(19) United States
(12) Patent Application Publication
(10) Pub. No.: US 2010/0210803 A1
(43) Pub. Date: Aug. 19, 2010

(54) NORBORNENE-BASED POLYMER HAVING LOW DIELECTRIC CONSTANT AND LOW-LOSS PROPERTIES AND INSULATING MATERIAL USING THE SAME

(75) Inventors: Jae-Choon CHO, Suwon-si (KR); Do-Young YOON, Seoul (KR); Jun-Rok OH, Seoul (KR); Hwa-Young LEE, Suwon-si (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 12/534,433

(22) Filed: Aug. 3, 2009

(30) Foreign Application Priority Data
Feb. 13, 2009 (KR) 10-2009-0012040

(51) Int. Cl. C08F 10/00; H01B 3/30

(52) U.S. Cl. 526/282

(57) ABSTRACT

It relates to a norbornene-based polymer having low dielectric constant which is thus suitable for a low loss dielectric material, an insulating material using the same, an embedded printed circuit board and a functional device, in which the norbornene-based polymer includes at least one repeat unit of formula 1:

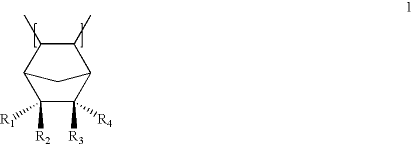

wherein, at least one of R1 to R4 may be independently selected from the group consisting of hydrogen,

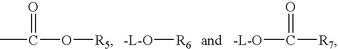

in which R5, R6 and R7 are each independently selected from the group consisting of hydrogen, substituted or unsubstituted C1-C6 alkyl, C1-C6 alkyl substituted with an aliphatic bicyclo or multicyclo compound, substituted or unsubstituted C2-C6 alkenyl and substituted or unsubstituted C4-C31 arylalkyl, L is C1-C3 alkyl.

### CROSS-REFERENCE TO RELATED APPLICATIONS

This application claims the benefit of Korean Patent Application No. 10-2009-0012040 filed with the Korean Intellectual Property Office on Feb. 13, 2009, the disclosure of which is incorporated herein by reference in its entirety.

### BACKGROUND

1. Technical Field

It relates to a norbornene-based polymer having a low dielectric constant and low-loss properties and an insulating material using the same.

2. Description of the Related Art

Growth of integrated circuits has allowed miniaturization of circuits and further allowed multifunctional and high performing products with high integration. Accordingly, interposers, packages, and printed circuit boards, etc. for providing electrical connection between integrated circuits mounted and another component have moved toward high integration. All components have been mounted on the surface of a board in conventional multilayer boards. However, there has been a large demand for embedded PCBs with higher densities, greater capabilities and smaller sizes in which a great number or a part of components are incorporated into internal layers. A package or board providing size reduction by 3-dimensional mounting of components and improved electrical performance at a high frequency is called as an embedded PCB.

Embedded printed circuit boards are multilayer printed circuit boards in which semiconductors and passive components are mounted and have high density, high performance and/or high frequency characteristics. Minicaturization of integrated circuits with high density(large-scale integration) has been developed for the demand of smaller, thiner and lighter weight of electronic devices and has been possible with ultra-fine wirings of integrated circuits. However, due to concerns of reducing electric power consumption and mounting of chip components, embedded PCBs, in which passive components are used and of which passive components are directly incorporated into internal layers, have been more demanded. Low loss dielectric (LLD) is a board material to be used as insulating materials or functional devices (e.g., filter, etc.) of radio frequency embedded boards. Lower cross talk and lower transmission loss is required for electronic devices with smaller in size and higher in frequency. Accordingly, there is a demand for researches on new insulating materials with low dielectric property and low loss and thus suitable for high frequency packaging and modules, etc. Materials having high Q value for embedding a filter and the like inside the package are also required for miniaturization. Low loss dielectrics play roles of insulating between wirings or between functional devices in the embedded PCB and of marinating the strength of packages. Much higher-density wirings are also required in packages along with using ultra-fine wirings and operation of high density integrated circuits at higher frequencies. Since such high density wirings may cause noises between wirings, dielectric constant of insulating materials, parastic capacitance and loss of dielectric have to be lowered to reduce insulating damages.

Benzocyclobuten (BCB) has been used for its excellent properties but cannot be suitable for printed circuit boards due to high cost. Liquid crystalline polymer(LCP) has also excellent properties but causes problems in the processing of printed circuit boards due to characteristics of thermoplastic resin. Therefore, it is highly demanded to develop new materials having insulating properties and processability.

### SUMMARY

It is to provide a novel norbornene-based polymer having low dielectric constant, processability and thermosetting properties as a low loss dielectric material, which is applicable for the material of embedded boards (e.g., insulating materials or functional elements), and an insulating material using the same.

Additional aspects and advantages will be set forth in part in the description which follows, and in part will be obvious from the description, or may be learned by practice.

### BRIEF DESCRIPTION OF THE DRAWINGS

FIG. 1 is a graph illustrating the TGA result of the norbornene polymer according to Experimental Example \textcircled{1}.

FIG. 2 is a graph illustrating the TGA result of the norbornene polymer according to Experimental Example \textcircled{1}.

FIG. 3 is a graph illustrating the DMA result of the norbornene polymer according to Experimental Example \textcircled{2}.

FIG. 4 is a graph illustrating the DMA result of the norbornene polymer according to Experimental Example \textcircled{2}.

FIG. 5 is a graph illustrating the WAXS structure of the norbornene polymer according to Experimental Example \textcircled{3}.

FIG. 6 is a graph illustrating the TGA result of the norbornene polymer according to Experimental Example \textcircled{4}.

FIG. 7 is a graph illustrating the DMA result of the norbornene polymer according to Experimental Example \textcircled{4}.

FIG. 8 is a graph illustrating the dielectric constant of the norbornene polymer according to Experimental Example \textcircled{4}.

FIG. 9 is a graph illustrating the tan δ value of the norbornene polymer according to Experimental Example \textcircled{4}.

FIG. 10 is a graph illustrating the TGA result of the norbornene polymer according to Experimental Example \textcircled{5}.

FIG. 11 is a graph illustrating the DMA result of the norbornene polymer according to Experimental Example \textcircled{5}.

FIG. 12 is a graph illustrating the TGA result of the norbornene polymer according to Experimental Example \textcircled{6}.

FIG. 13 is a graph illustrating the DMA result of the norbornene polymer prepared according to Experimental Example \textcircled{6}.

FIG. 14 illustrates solubilities of cured and non-cured samples of the norbornene polymer according to Experimental Example \textcircled{7}.

### DETAILED DESCRIPTION

Various norbornene-based polymers have been developed by preparing various norbornene derivatives, polymerizing them and conducting experiments to determine dielectric contants, dielectric loss factors, pyrolysis onset temperatures and glass trasition temperatures of those polymers to provide novel insulating materials having low dielectric constant and processability as well as low loss property in order to resolve the problems described above.

According to an aspect, there is provided a norbornene-based polymer having at least one repeat unit expressed by the following formula 1 to solve the problems described above:

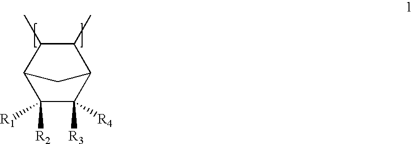

wherein, at least one of R1 to R4 is independently chosen from hydrogen,

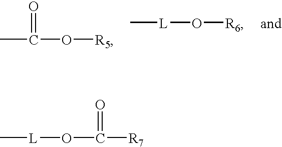

in which R5, R6 and R7 are each independently chosen from hydrogen, substituted or unsubstituted C1-C6 alkyl, C1-C6 alkyl substituted with an aliphatic bicyclo or multicyclo compound, substituted or unsubstituted C2-C6 alkenyl and substituted or unsubstituted C4-C31 arylalkyl; and L is C1-C3 alkyl.

According to an embodiment, R1 and R4 may be hydrogen, R2 and R3 may be each chosen from

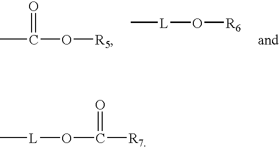

According to an embodiment, R2 and R3 may be same or different.

According to an embodiment, R6 and R7 may be each independently chosen from hydrogen, methyl, ethyl, propyl, butyl, pentyl and hexyl.

According to an embodiment, R5, R6 and R7 may be each independently chosen from vinyl,

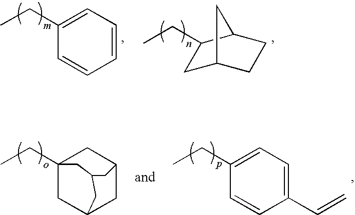

wherein m, n, o and p may be each independently an integer of 1 to 3.

According to an embodiment, at least one end of R1 to R4 may have acryl or vinyl group.

According to an embodiment, the norbornene polymer may include at least two repeat units expressed by the formula 1.

According to an embodiment, at least one repeat unit of the at least two repeat units of the copolymer may have acryl or vinyl group at at least one end of R1 to R4.

According to an embodiment, the norbornene-based polymer may further include a repeat unit expressed by the following formula 2.

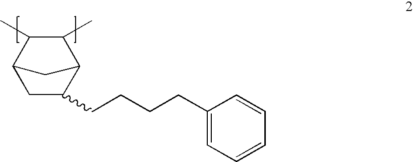

According another aspect of embodiments, there is provided an insulating material using the norbornene-based polymer.

According to an embodiment, the insulating material may be used in embedded printed circuit boards or functional devices.

The norbornene-based polymer thus prepared may have low dielectric constant, low loss properties, excellent processability and thermosetting properties so that it allows various applications as an insulation material in embedded boards or functional devices.

### DETAILED DESCRIPTION

Hereinafter, embodiments will be described in more detail.

Norbornene-Based Polymer

The term “norbornene-based” is a monomer including at least one norbornene moiety of the following structure A or a polymer formed from such monomers or a polymer including at least one repeat unit of the following structure B.

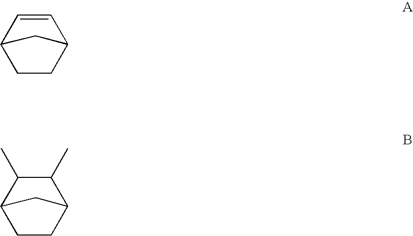

The term “addition polymerization of norbornene derivatives” is an addition polymerization reaction to provide a polymer containing a repeat unit which is formed through the 2,3-bonding of the double bond in the norbornene derivative monomer of the structure A. Such polymers can be produced from norbornen-based monomers under a Group VIII transition metal system as disclosed in WO97/20871 (Publication date: Jun. 12, 1997), the disclosure of which is incorporated herein by reference in its entirety.

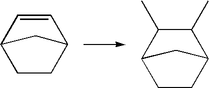

The term “low loss insulating material(low loss dielectrics)” can be used as an insulating material in various electronic components and be also an electrical insulating material having high-frequency transmission characteristics which exhibits low transmission loss at a high frequency region.

The norornene monomer of the norbornene-based polymer may have ester, ether or carboxyl group and at least one repeat unit expressed by the following formula 1:

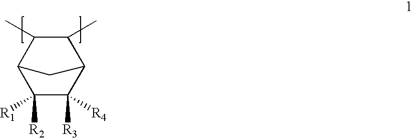

wherein, at least one of R1 to R4 may be independently chosen from hydrogen,

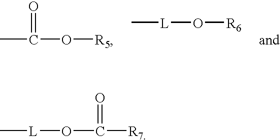

The ester, ether or carboxyl group may be attached in the exo position. The R2 and R3 in the exo positions may be same or different.

The ester, ether or carboxyl group may be bonded directly to the norbornene or at a certain distance through alkyl group. It may be bonded by a C1 to C3 alkyl linker(L).

Hydrogen, substituted or unsubstituted C1-C5 alkyl(including alkanyl, alkenyl, alkynyl) or substituted or unsubstituted C4-C31 arylalkyl may be attached at the opposite end to the ester, ether or carboxyl group of the norbornene.

R5, R6 and R7 may be each independently chosen from hydrogen, alkyl such as methyl, ethyl, propyl, butyl, pentyl, hexyl and the like; a cyclic alkyl such as

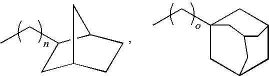

(n and o are each an integer of 1 to 3) and the like; and arylalkyl such as

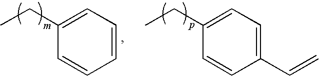

(m and p are each an integer of 1 to 3) and the like.

The arylalkyl may be aryl-substituted alkyl and examples may include the following formulas:

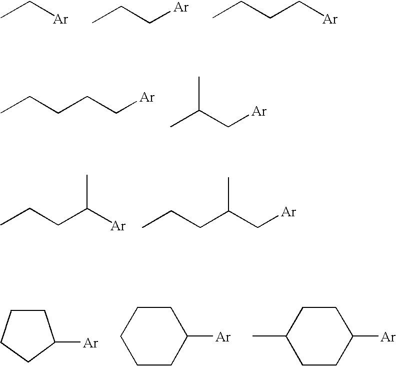

wherein, Ar may be aryl including polyaryl and heteroary, preferably phenyl.

Further, R5, R6 and R7 may each independently have a vinyl group at the end position so that at least one end of R1 to R4 may have acryl or vinyl group which thus provides thermosetting property to the polymer.

According to an embodiment, the norbornene-based polymer may be composed of the repeat unit expressed by the following formula 3:

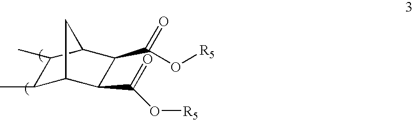

wherein, R5 is methyl, ethyl, propyl, butyl, pentyl or hexyl.

According to an embodiment, the norbornene-based polymer may be composed of the repeat unit of the following formula 4:

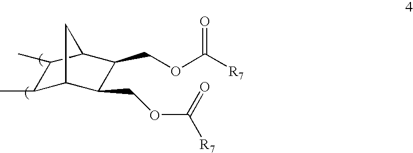

wherein, R7 is methyl, ethyl, propyl, butyl, pentyl or hexyl.

According to an embodiment, the norbornene-based polymer may be composed of the repeat unit of the following formula 5:

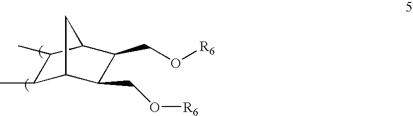

wherein, R6 is methyl, ethyl, propyl, butyl, pentyl or hexyl.

According to an embodiment, the norbornene-based polymer may be composed of the repeat unit of the following formula 6:

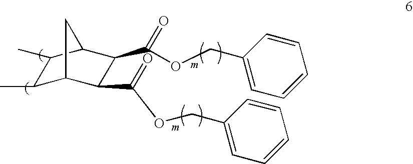

wherein, m is an integer of 1 to 3.

According to an embodiment, the norbornene-based polymer may be composed of the repeat unit of the following formula 7:

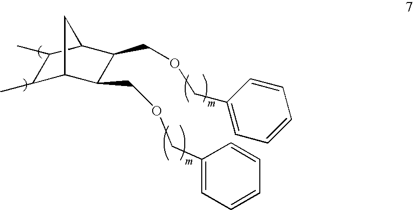

wherein, m is an integer of 1 to 3.

According to an embodiment, the norbornene-based polymer may be composed of the repeat unit of the following formula 8:

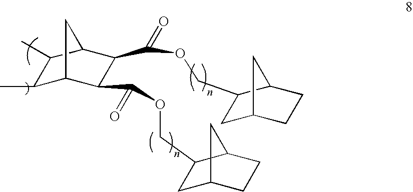

wherein, m is an integer of 1 to 3.

According to an embodiment, the norbornene-based polymer may be composed of the repeat unit of the following formula 9:

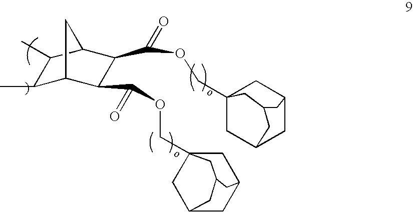

wherein, m is an integer of 1 to 3.

According to an embodiment, the norbornene-based polymer may be composed of the repeat unit having acryl or vinyl at the end position expressed by the following formulas 10 to 12

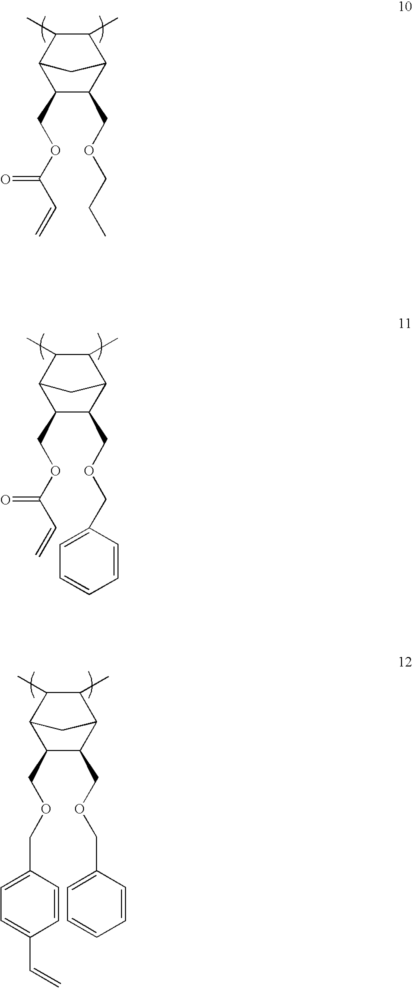

The norbornene-based polymer may have an average number of 250 to 400 repeat units described above but it is not limited thereto.

The norbornene-based polymer may be a copolymer including 2 or more of the repeat units described above.

According to an embodiment, at least one of the 2 or more of the repeat units may have acryl or vinyl at at least one end of R1 to R4.

According to an embodiment, the norbornene-based polymer may be a copolymer further including the repeat unit disclosed in KR Patent Application No. 10-2008-0089758, the disclosure of which is incorporated herein by reference in its entirety. For example, the norbornene-based polymer may be a copolymer further including the repeat unit expressed by the following formula 2:

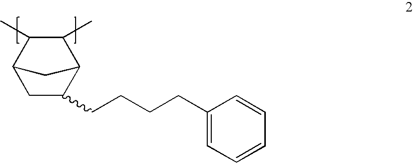

According to an embodiment, the norbornene-based polymer may be a copolymer including the 2 repeat units of the repeat unit of formula 9 and the repeat unit of formula 11.

According to an embodiment, the norbornene-based polymer may be a copolymer including the 2 repeat units of the repeat unit of formula 2 and the repeat unit of formula 10. The norbornene-based polymer may be a copolymer including the 2 repeat units of the repeat unit of formula 2 and the repeat unit of formula 10 in a mole ratio of 10:1 to 1:1.

According to an embodiment, the norbornene-based polymer may be a copolymer including the 2 repeat units of the repeat unit of formula 2 and the repeat unit of formula 11. The norbornene-based polymer may be a copolymer including the 2 repeat units of the repeat unit of formula 2 and the repeat unit of formula 11 in a mole ratio of 95:5 to 80:20.

According to an embodiment, the norbornene-based polymer may be a copolymer including the 2 repeat units of the repeat unit of formula 2 and the repeat unit of formula 12. The norbornene-based polymer may be a copolymer including the 2 repeat units of the repeat unit of formula 2 and the repeat unit of formula 12 in a mole ratio of 95:5 to 80:20.

According to an embodiment, the norbornene-based polymer may have a dielectric constant of 2.62 at 1GHz to 2.99 at 1GHz, a dielectric loss tangent(tan δ) of 0.007 at 1 GHz to 0.029 at 1 GHz, a pyrolysis onset temperature (Td5) of 350° C. to 400° C., and a glass transition temperature of 176° C. to 331° C.

The norbornene-based polymer may not only maintain its own low diectric characteristics but also exhibit excellent processability due to the bonded functional groups.

As noted in Examples to be described below, a film prepared with the polymer according to an embodiment may begin pyrolysis at 350° C. or higher and have the glass transition temperature of 240° C. or higher so that it may have thermal and mechanical stabilities. Further, such prepared film may be transparent and flexible and exhibit good adhesion during the spin coating.

Therefore, the norbornene-based polymer may be used as a low loss dielectric material.

According to another aspect, there is provided an insulating material formed by using the norbornene-based polymer. The insulating material may be used in embedded printed circuit boards or functional devices.

A method for manufacturing organic substrates does not require a sintering process so that the manufacturing process may be simplified.

Further, the insulating material may be used as a substrate resin and when it is used as a substrate resin, it may reduce noises between patterns and insulation losses. The insulating material may be used in any structure requiring a low dielectric property such as fillers of a substrate, insulating layers of a substrate and glass fibers without any limitation.

Further, the insulating material may be used in the embedded boards and functional devices in which a great number or a part of components can be embedded.

According to another aspect, there is provided an embedded printed circuit board or functional device including the insulating material.

According to another aspect, there is provided a method for manufacturing a norbornene-based polymer including: preparing a Pd(II)-based catalyst; preparing a monomer; and polymerzing the monomers by using the Pd(II)-based catalyst.

An example of the Pd(II)-based catalyst may include (6-methoxybicyclo[2.2.1]hept-2-en-endo-5σ,2π)-palladium(II) hexafluoroantimonate.

Hereinafter, although more detailed descriptions will be given by examples and preparation examples, those are only for explanation and there is no intention to limit the invention.

### Preparation Examples

In the following Preparation Examples, air or moisture-sensitive materials were prepared by measuring in a dry box and using Schlenk flask. Some of starting materials in each step, catalysts and solvents, etc. were purchased from ACROS, Aldrich, Lancaster and TCI, etc.

(1) Synthesis of Catalyst

### Synthesis of (Bicyclo[2.2.1]hepta-2,5-diene)dichloro palladium(II)

Platinum chloride(II) (1.97 g, 11.1 mmol) was dissolved in the atmosphere in 5 mL of a concentrated HCl solution at 50° C. After 1 hour, the reaction solution was cooled to room temperature, diluted with 100 mL of ethanol, filtered and washed with 50 mL of ethanol. Norbornadiene (2.7 mL, 25 mmol) was slowly added to the reaction solution with vigorous stirring. Yellow solid was pacipitated out. After vigorous stirring for 10 minutes, the precipitates were filtered and washed with diethyl ether. Yellow powder was dried under vacuum to provide (bicyclo[2.2.1]hepta-2,5-diene)dichloro palladium(II).

Yield: 2.85 g (95.3%)

mp: 192-198° C. (decomposed)

¹H NMR (DMSO-d₆): δ=6.76 (t, 4H), 3.55 (quin, 2H), 1.87 (t, 2H)

¹³C NMR (DMSO-d₆): δ=143.1, 74.8, 50.4

### Synthesis of Di-μ-chloro-bis-(6-methoxybicyclo[2.2.1]hept-2-en-endo-5σ,2π)-palladium(II)

The obtained (bicyclo[2.2.1]hepta-2,5-diene)dichloro palladium(II) (0.545 g, 2.02 mmol) in 8 mL of dried methanol was stirred under Ar at a temperature of −60° C. to −40° C. Sodium methoxide solution (5.0 mL (0.5 M), 2.5 mmol) was slowly added to the reaction solution. After stirring for 45 minutes, white milky solution was filtered and the powder was washed with cold methanol and dried under vacuum to provide di-μ-chloro-bis-(6-methoxybicyclo [2.2.1]hept-2-en-endo-5σ,2π)-palladium(II).

Yield: 0.37 g (69.0%)

### Synthesis of (6-Methoxybicyclo[2.2.1]hept-2-en-endo-5σ,2π)-palladium(II) hexafluoroantimonate (Catalyst I)

Equimolar amount of each of di-μ-chloro-bis-(6-methoxybicyclo[2.2.1]hept-2-en-endo-5σ,2π)-palladium(II) and AgSbF₆ was dissolved in chlorobenzene. The AgSbF₆ solution was added to the solution of di-p-chloro-bis-(6-methoxybicyclo[2.2.1]hept-2-en-endo-5σ,2π)-palladium(II) to provide in situ an active solution of (6-methoxybicyclo[2.2.1]kept-2-en-endo-5σ,2π)-palladium(II) hexafluoroantimonate (catalyst I). AgCl was removed by filtering with a syringe filter to provide (6-methoxybicyclo[2.2.1]hept-2-en-endo-5σ,2π)-palladium(II) hexafluoroantimonate (catalyst I).

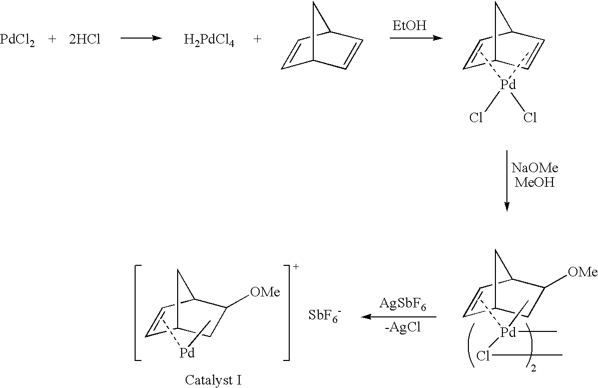

(2) Synthesis of Monomer

### \textcircled{1} Synthesis of 5-norbornene-exo-2,3-dicarboxylic anhydride

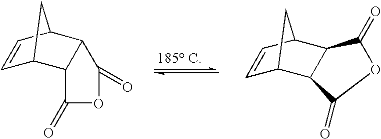

A commercially available cis-5-norbornene-endo-2,3-dicarboxylic anhydride was heated at 185° C. for 4 hours by using a heating mantle and then cooled down to room temperature. The produced precipitates were purified by recrystallizing 4 times with ethyl acetate. The purified result was repeated for the process of rearrangement, cooling and recrystallization 3 times to provide cis-5-norbornene-exo-2,3-dicarboxylic anhydride having 98% or higher of purity.

### \textcircled{2} Synthesis of norbornene-exo,exo-2,3-dicarboxylic acid dialkyl ester

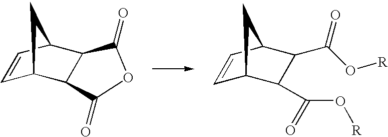

5-Norbornene-exo,exo-2,3-dicarboxylic anhydride and p-toluenesulfonic acid, monohydrate were dissolved in each aliphatic alcohol of methanol, ethanol, 1-propanol, 1-butanol, 1-pentanol and 1-hexanol and each reaction solution was heated at reflux overnight. Each reaction solution was extracted with an organic solvent and water. Each organic layer was dried over anhydrous Na₂SO₄ and each solvent was evaporated by using a rotary evaporator. Each crude product was purified by column chromatography to provide each of methyl-, ethyl-, propyl-, butyl-, pentyl- and hexyl-substituted product.

### \textcircled{3} Synthesis of norbornene-exo,exo-2,3-dicarboxylic acid dialkylphenyl ester

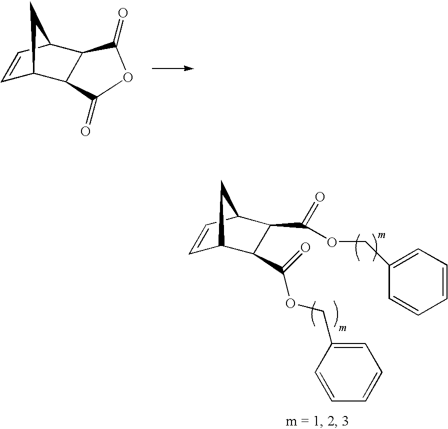

Norbornene-exo-2,3-dicarboxylic anhydride, each of aromatic alcohols of methylphenyl alcohol, ethylphenyl alcohol and propylphenyl alcohol and p-TsOH were dissolved in toluene and heated at reflux at 145° C. in a flask equipped with a Dean-Stark trap for 24 hours. Each reaction mixture was extracted with ethyl acetate and water and each organic layer was dried over Na₂SO₄ and each solvent was evaporated by using a rotary evaporator. Each crude product was purified by column chromatography to provide each final product.

### \textcircled{4} Synthesis of norbornene-exo,exo-2,3-dicarboxylic acid dinorbornane methyl ester

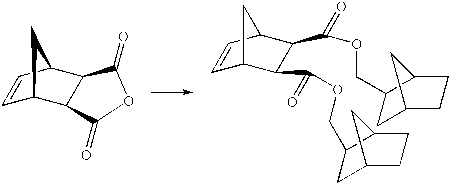

Norbornene-exo-2,3-dicarboxylic anhydride, 2-norbornane methanol and p-TsOH were dissolved in toluene and heated at reflux at 145° C. in a flask equipped with a Dean-Stark trap for 24 hours. The reaction mixture was extracted with ethyl acetate and water and the organic layer was dried over anhydrous Na₂SO₄ and the solvent was evaporated by using a rotary evaporator. The crude product was purified by column chromatography to provide a final product.

### \textcircled{5} Synthesis of cis-norbornene-exo-2,3-dimethanol

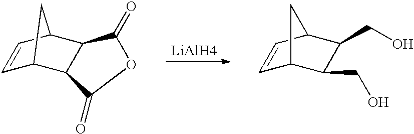

Cis-5-norbornene-exo-2,3-dicarboxylic anhydride dissolved in THF was added drop-wise to LiAlH₄, which was previously dissolved in THF at 0° C., using a dropping funnel and reacted for 24 hours. The reaction solution was then quanced with distilled water and an aqueous solution of 15% NaOH. Ths suspension was filtered through a glass filter funnel and the filtrate was extracted with ethyl acetate and distilled water. The organic layer was dried over anhydrous Na₂SO₄ and the solvent was evaporated by using a rotary evaporator. The crude product was purified by column chromatography to provide a final product.

### \textcircled{6} Synthesis of norbornene-exo,exo-2,3-dimethyl dicarboxylate

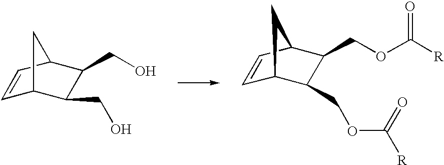

Cis-norbornene-exo-2,3-dimethanol(2,3-bishydroxymethyl norbornene), triethyl amine and each of acetic anhydride, propionyl chloride, butyryl chloride, valeryl chloride and hexanoic acid were reacted and purified to provide each final product.

\textcircled{7} Synthesis of cis-norbornene-exo-2-methanol-exo-3-methyl alkyl ether and cis-norbornene-exo-2,3-di(methyl alkyl)ether

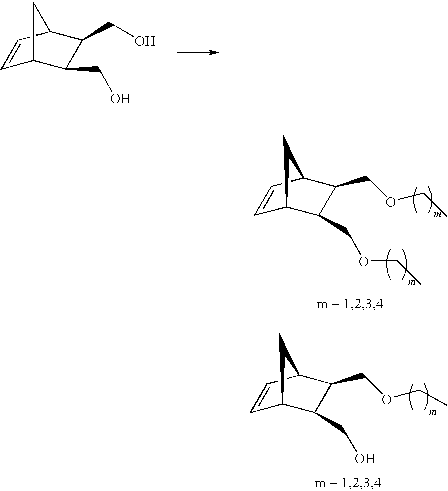

Cis-norbornene-exo-2,3-dimethanol was dissolved in DMF and 1.2 equivalent of NaH to cis-norbornene-exo-2,3-dimethanol was added thereto at 0° C. 1.2 Equivalent of each of ethyl bromide, propyl bromide, butyl bromide and pentyl bromide was added to the reaction solution and reacted for 12 hours. Each reaction solution was quenched with distilled water and the suspension was extracted with ethyl acetate and distilled water. Each organic layer was dried over anhydrous Na₂SO₄ and each solvent was evaporated by using a rotary evaporator. Each crude product was purified by column chromatography to provide each final product.

Norornene monomers of the following formulas were prepared by the Diels-Alder reaction similarly as described above.

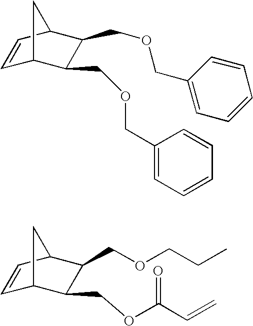

As described in Preparation Examples, a general scheme is as follows.

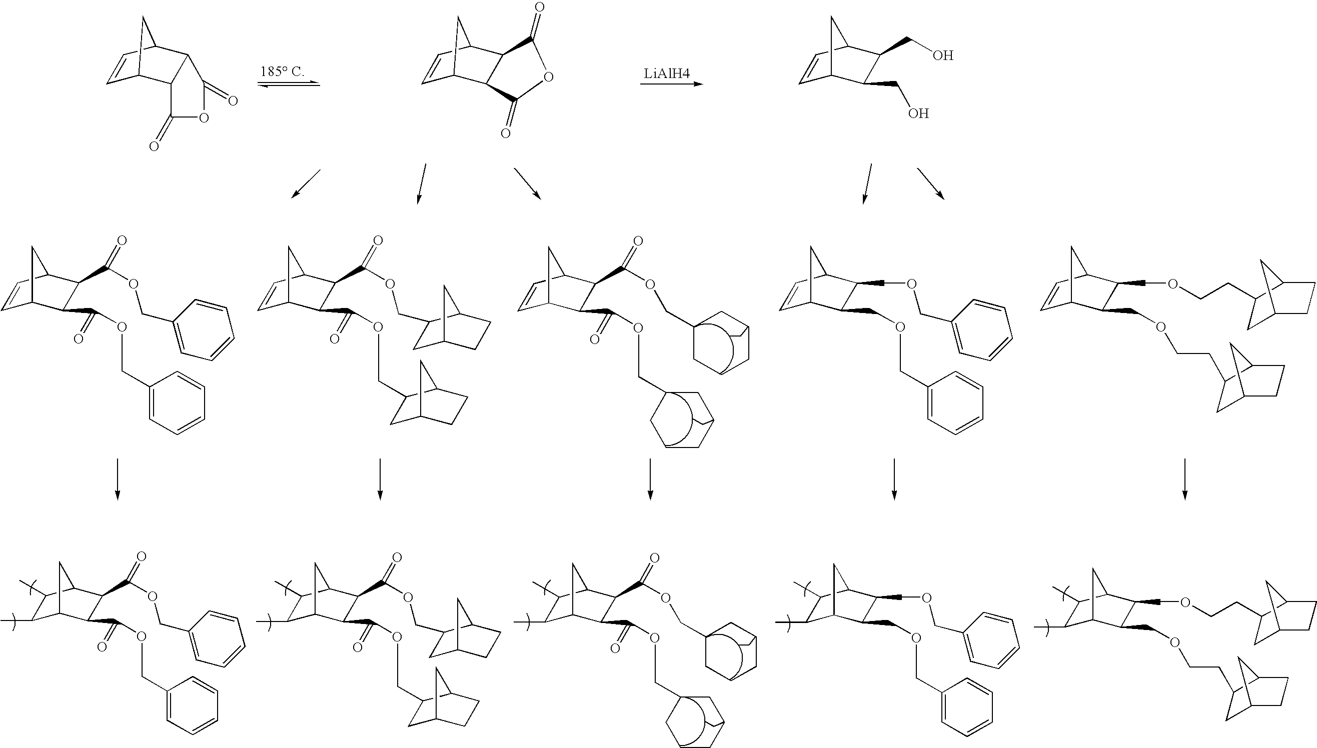

\textcircled{8} Synthesis of 2-(4-phenylbutyl)-5-norbornene

150 mL of a steel pressure vessel was charged with dicyclopentadien (46.65 g, 0.35 mol) and 6-phenyl-1-hexene (113 g, 0.71 mol) under Ar. The reaction solution was stirred for 1 hour and heated at 240° C. for 12 hours. The reaction solution was cooled and 6-phenyl-1-hexene was removed by evaporation. The residue was performed for the fractional distillation to provide 2-(4-phenylbutyl)-5-norbornene. Exo/endo mixture of 2-(4-phenylbutyl)-5-norbornene was produced by the Diels-Alder reaction of dicyclopentadien and 6-phenyl-1-hexene. When the reaction solution was heated to 100° C. or higher, dicyclopentadien was converted to cyclopentadien which immediately reacted with 6-phenyl-1-hexene by the retro-Diels-Alder reaction. The Diels-Alder condensation of cyclopentadiene and an ethylene derivative provided 2 norbornene derivatives of exo and endo isomers. Here, in most of cases endo isomer was preferable according to Alder's rule.

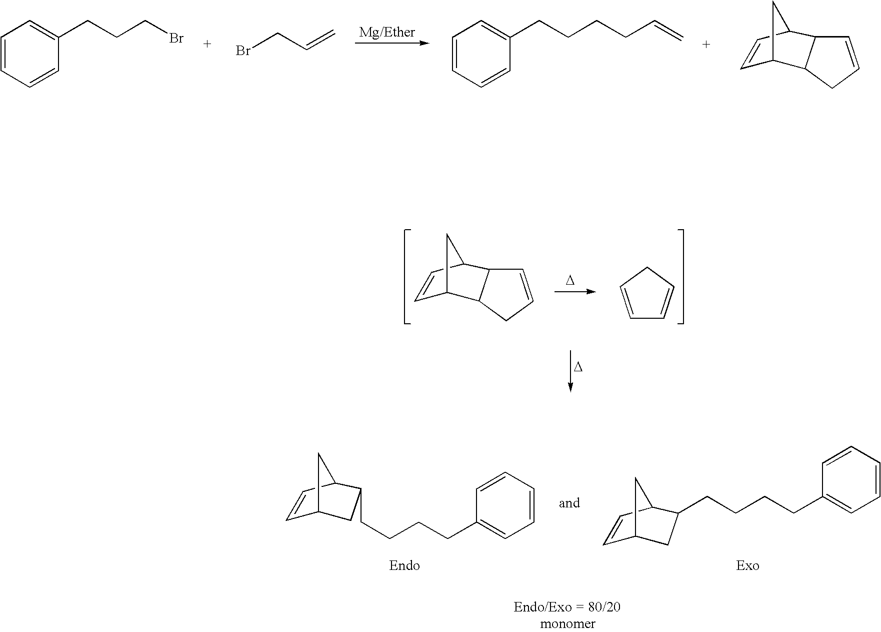

(3) Synthesis of Polymer

The catalyst III prepared in (1) and each monomer prepared in (2) was polymerized in dry chlorobenzene, in which moisture was distilled out, under Argon for 1 to 3 days. Some of them were homopolymerized and copolymerized by using a commercially available catalyst. For monomers having unstable acrylates as a thermosetting group, hydroquinone was used as an inhibiting agent to protect such groups so that the thermosetting groups were presented on the polymer and able to be crosslinked even after the polymerization.

### Experimental Examples

### \hat{1} Determination of Thermal Stability by the TGA (Thermal Gravimetric Analysis)

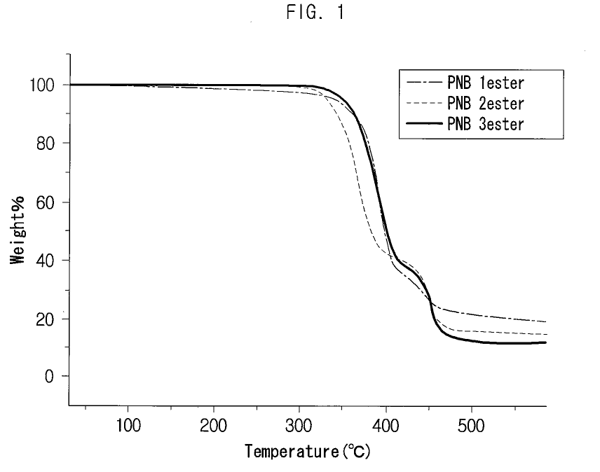

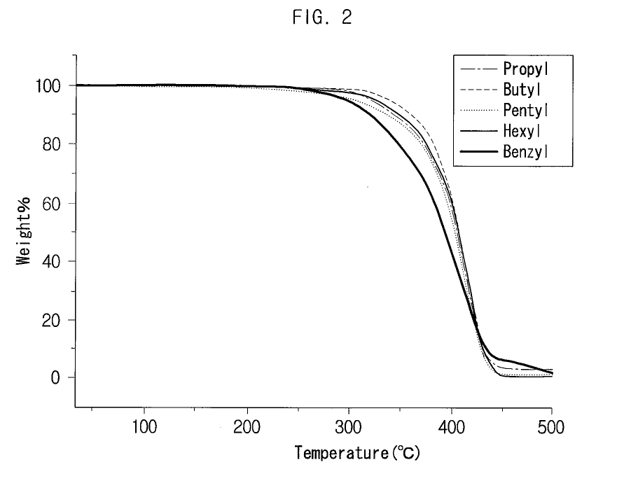

FIGS. 1 and 2 are graphs illustrating the TGA. In FIG. 1, PNB 1 ester, PNB 2 ester and PNB 3 ester are the compounds of formula 6 in which m is 1, 2, and 3, respectively. In FIG. 2, propyl, butyl, pentyl, hexyl and benzyl are substituents at R₅ of formula 3. During the pyrolysis of polynorbornene substitutents bonded as ester or ether bonds, molecular weight reduction was shown at 300° C. or higher for all polynorbornenes which expressed high thermal stability. The pyrolysis onset time was varied with polynorbornenes but their backbone breakings were appeared at 300° C. or higher.

### \textcircled{2} Determination of Glass Transition Temperature by the DMA (Dynamic Mechanical Analysis)

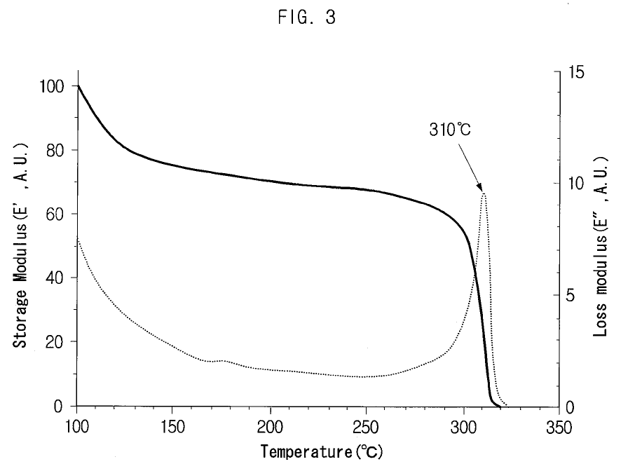

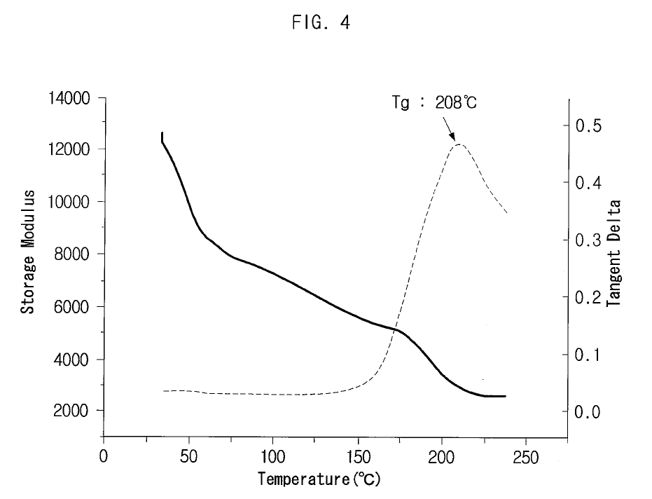

FIGS. 3 and 4 are graphs illustrating the DMA. FIG. 3 is the case where R₇ of formula 4 is a propyl group and R₅ of formula 3 is a hexyl group. The glass transition temperature can be usually determined by the differential scanning calorimetry (DSC) but it cannot be for polynorbornene polymers. Unlike the DSC, the DMA determines glass transition temperature through modulus analysis, not thermal analysis. Since a polynorbornene has a rigid backbone, it is known that when it does not have any substituent, its glass transition temperature is very high (>370° C). When substituents are introduced, it is also noted from the DMA graphs that its glass transition temperature is lowered to 300° C. or below. However, most of polynorbornenes have higher than the desired glass transition temperature of 180° C.

### \textcircled{3} Structure Determination by the WAXS (Wide-Angle X-Ray Scattering)

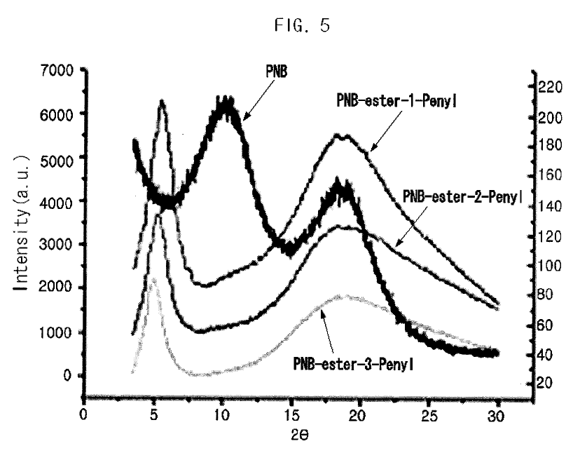

Structures of polynorbornene polymers were determined with changes of two strong scattering peaks by the wide-angle X-ray scattering. The result was shown in FIG. 5 and Table 1. Here, PNB is an unsubstituted polynorbornene and PNB-ester-1-phenyl, PNB-ester-2-phenyl and PNB-ester-3-phenyl are the compounds of formula 6 in which m is 1, 2, and 3, respectively. It is noted that 2θ values(the third row in Table 1) in FIG. 5 are influeced by the distance between neighboring CH₂ groups so that they are little changes (d-spacing; 4.69-4.70) even though the length of alkyl chains increases but 2θ values (the second row in Table 1) are influenced by interchain spacings so that they shift toward lower angles (d-spacing; 16.1-17.8) as the length of alkyl chains increases. It is considered that d-spacing values are increased with increase in steric repulsion between alkyl chains due to the length of longer alkyl chains. It is identified when the d-spacing values are compared with those of unsubstituted polynorbornenes.

TABLE 1
d-spacing

| polymer | First peak (Å) | Second peak (Å) |
|---|---|---|
| PNB-ester-1-phenyl | 16.1 | 4.70 |
| PNB-ester-2-phenyl | 16.8 | 4.74 |
| PNB-ester-3-phenyl | 17.8 | 4.69 |
| PNB | 8.6 | 4.80 |

### \textcircled{4} Determination of Physical Properties of PNB-ester-2-phenyl

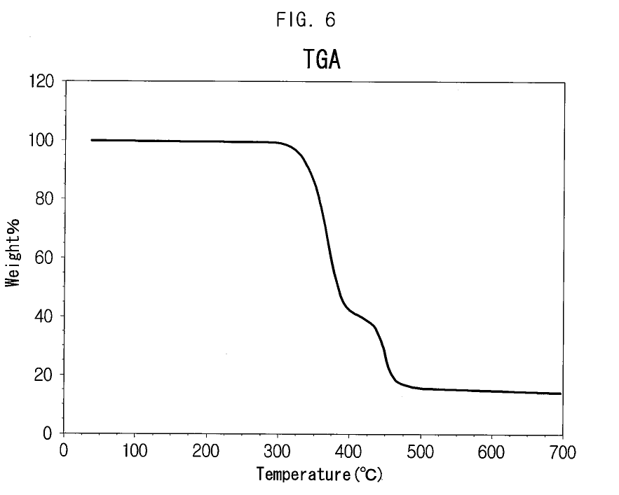

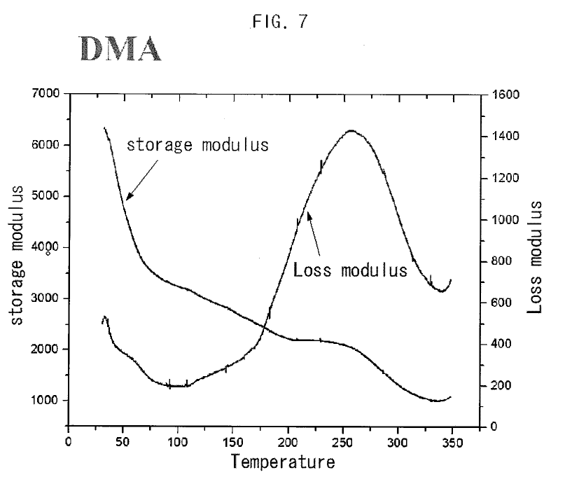

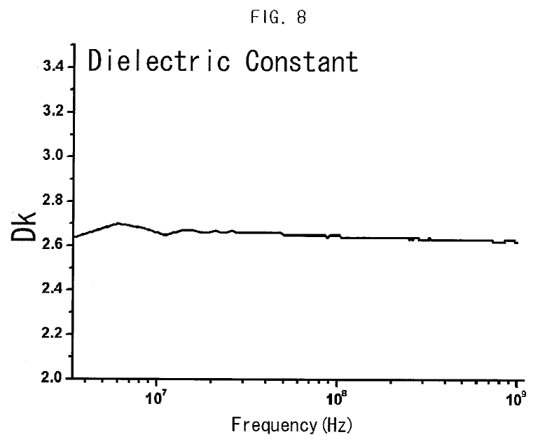

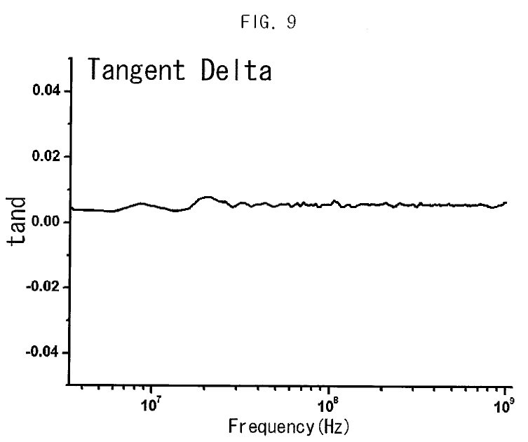

TGA (Thermal gravimetric anaylsis), DMA (Dynamic mechanical analysis), dielectric constant and tan 6 value of PNB-ester-2-phenyl, where m is 2 in formula 6, are shown in FIG. 6, FIG. 7, FIG. 8 and FIG. 9, respectively. Number average molecular weight (Mn), weight average molecular weight (Mw), polydispersity (Mw/Mn) and refractive index of PNB-ester-2-phenyl were 27,000, 35,000, 1.3 and 1.55, respectively. It was stable against heat up to 400° C. and its glass transition temperature was 250° C. Dk was 2.63 and Tan δ was 0.005 at 500 MHz and Dk was 2.62 and Tan δ was 0.006 at 1 GHz.

### \textcircled{5} Determination of Physical Properties of PNB-ester-1-norbornane

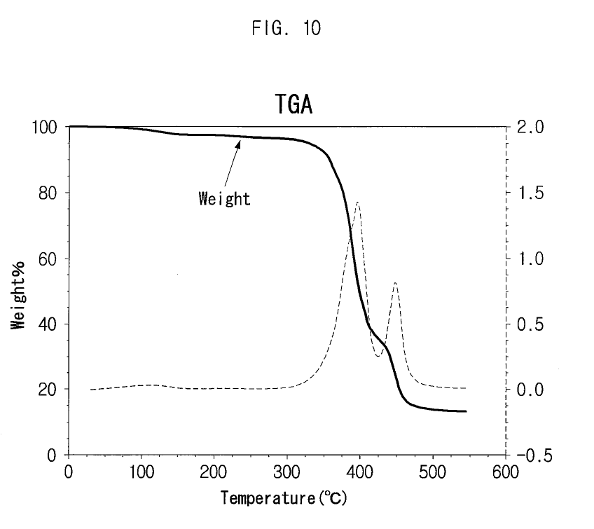

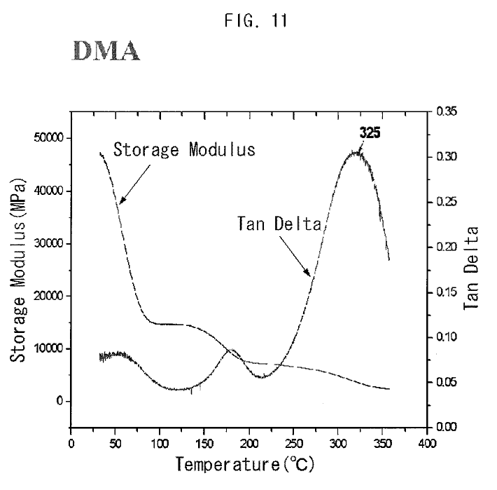

TGA and DMA of PNB-ester-1-norbornane, where m is 1 in formula 8, were determined and shown in FIGS. 10 and 11. Mn, Mw, PDI, refractive index of PNB-ester-1-norbornane were 23,300, 46,000, 1.97 and 1.51, respectively. It was stable against heat up to 400° C. and its glass transition temperature was 175° C. and 325° C.

### \textcircled{6} Determination of Physical Properties of PNB-ester-2-adamantane

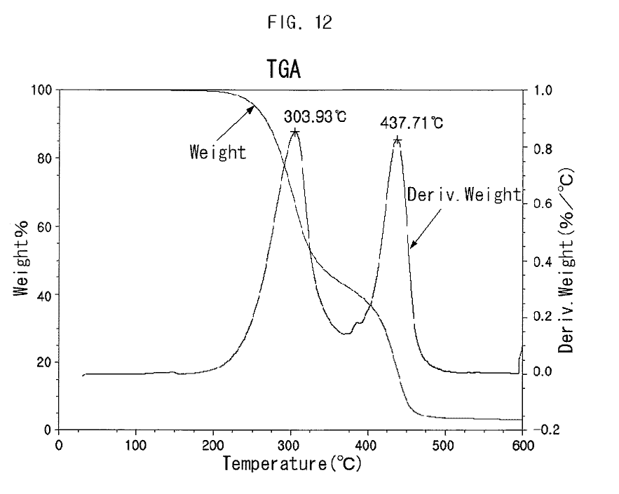

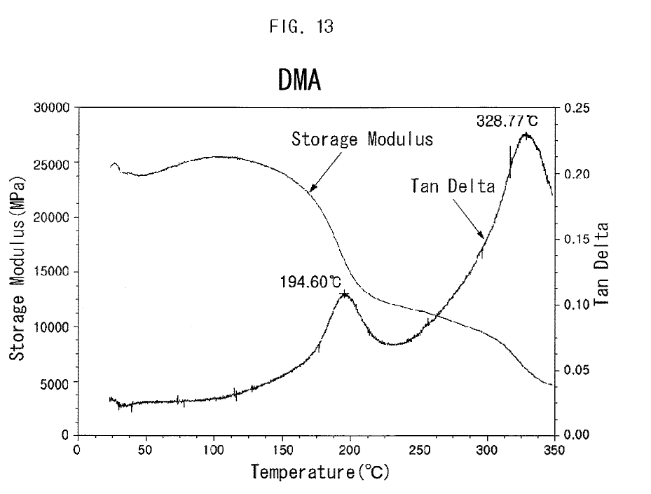

TGA and DMA of PNB-ester-2-adamantane, where o is 2, were determined and shown in FIGS. 12 and 13. Mn, Mw, PDI, refractive index of PNB-ester-2-adamantane were 51,000, 97,000, 1.9 and 1.51, respectively. It was stable against heat up to 400° C. and its glass transition temperature was 190° C. and 320° C.

### \textcircled{7} Set Up for Cure Conditions by the DSC and Determination of Cure Behaviors by Solubility

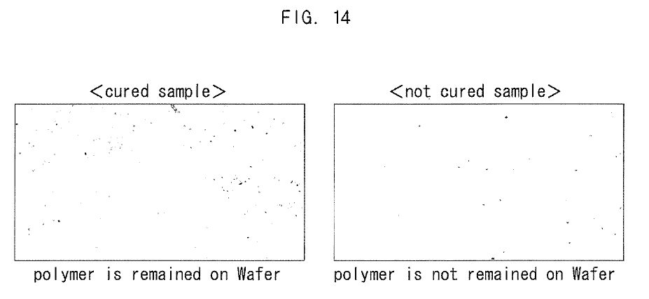

In the differential scanning calorimeter(DSC) analysis for the polynorbornene with a thermosetting group(formula 10), an exothermal peak was observed at 140° C.-180° C. which demonstrated cure was occurred. A film was prepared by spin-coating with a polymer solution on a Si-wafer and curing in a vacuum oven at 190° C. for 1 hour. This film was compared with a film which was not cured. Both films were placed in THF for 1 hour. The cured film did not dissolved in THF and maintained its own color when it was coated. On the other hand, the film which was not cured was completely dissolved in THF and the surface of Si-wafer was appeared as shown in FIG. 14.

### \textcircled{8} Determination of Physical Properties of Copolymers According to Mole Ratio

Physical properties were determined according to a mole ratio between the copolymer A including the repeat unit of formula 2(X) and the repeat unit of formula 11(Y) and the copolymer B including the repeat unit of formula 2(X) and the repeat unit of formula 12(Y). The result was summarized in Table 2 and Table 3.

TABLE 2

| | | | Mw | | | |
|---|---|---|---|---|---|---|
| Sample | X (mol %) | Y (mol %) | (GPC) | Mn (GPC) | PDI | Yield (%) |
| A1 | 95 | 5 | 62,100 | 40,400 | 1.5 | 66 |
| A2 | 90 | 10 | 63,100 | 34,600 | 1.8 | 70 |
| A3 | 85 | 15 | 84,900 | 42,500 | 2.0 | 61 |
| A4 | 80 | 20 | 98,000 | 41,900 | 2.3 | 66 |
| B1 | 95 | 5 | 59,300 | 34,000 | 1.7 | 70 |
| B2 | 90 | 10 | 61,500 | 33,300 | 1.8 | 66 |
| B3 | 85 | 15 | 76,300 | 33,000 | 2.3 | 64 |
| B4 | 80 | 20 | 68,300 | 29,700 | 2.3 | 59 |

TABLE 3

| | Film | | | | |
|---|---|---|---|---|---|
| | thickness | | | _{d1} (° C.) | T_{d1} (° C.) |
| Sample | (μm) | εᵣ (1 GH) | tanδ (1 GHz) | Cure | Cure |
| A1 | 410 | 2.51 | 1.60 × 10⁻³ | 87 | 313 |
| A2 | 460 | 2.60 | 2.97 × 10⁻³ | 280 | 309 |
| A3 | 430 | 2.79 | 4.10 × 10⁻³ | 263 | 301 |
| A4 | 450 | 2.83 | 5.44 × 10⁻³ | 276 | 296 |
| B1 | 450 | 2.61 | 4.61 × 10⁻⁴ | 299 | 320 |
| B2 | 560 | 2.64 | 1.62 × 10⁻³ | 298 | 323 |
| B3 | 480 | 2.73 | 2.49 × 10⁻³ | 280 | 313 |
| B4 | 510 | 2.71 | 3.07 × 10⁻³ | 291 | 310 |

While it has been described with reference to particular embodiments, it is to be appreciated that various changes and modifications may be made by those skilled in the art without departing from the spirit and scope of the embodiment herein, as defined by the appended claims and their equivalents.

What is claimed is:

1. A norbornene-based polymer comprising at least one repeat unit expressed by formula 1: 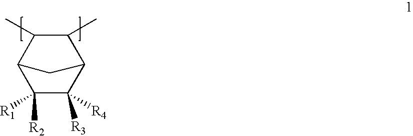
wherein,
at least one of R1 to R4 is independently selected from the group consisting of 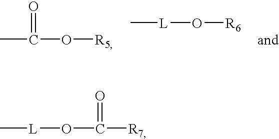
and the rest is hydrogen,
in which R5, R6 and R7 are each independently selected from the group consisting of hydrogen, substituted or unsubstituted C1-C6 alkyl, C1-C6 alkyl substituted with an aliphatic bicyclo or multicyclo compound, substituted or unsubstituted C2-C6 alkenyl and substituted or unsubstituted C4-C31 arylalkyl, L is C1-C3 alkyl.

2. The norbornene-based polymer of claim 1, wherein the R1 and R4 are hydrogen, R2 and R3 are each selected from the group consisting of

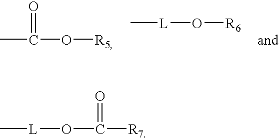

3. The norbornene-based polymer of claim 1, wherein the R5, R6 and R7 are each independently selected from the group consisting of hydrogen, methyl, ethyl, propyl, butyl, pentyl and hexyl.

4. The norbornene-based polymer of claim 1, wherein the R5, R6 and R7 are each independently selected from the group consisting of vinyl, 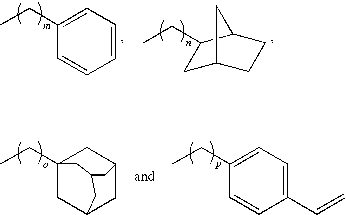
in which m, n, o and p are each independently an integer of 1 to 3.

5. The norbornene-based polymer of claim 1, wherein the at least one end of R1 to R4 has an acryl or vinyl group.

6. The norbornene-based polymer of claim 1, wherein the norbornene-based polymer has at least 2 repeat units expressed by the formula 1.

7. The norbornene-based polymer of claim 6, wherein at least one of the at least two repeat units has acryl or vinyl group at at least one end of R1 to R4.

8. The norbornene-based polymer of claim 1, further comprising a repeat unit expressed by the following formula 2:

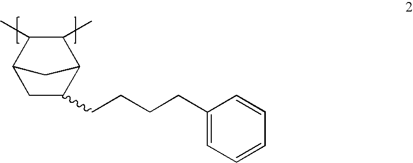

9. An insulating material prepared by using the norbornene-based polymer of claim 1.

10. An embedded printed circuit board or functional device comprising the insulating material of claim 9.
